(19) United States
(12) Patent Application Publication
(10) Pub. No.: US 2015/0275539 A1
(43) Pub. Date: Oct. 1, 2015

(54) COLUMBARIUM NICHE COVER

(71) Applicant: Rayzist Photomask, Inc., Vista, CA (US)

(72) Inventors: Randy Willis, Vista, CA (US); Roderick Geis, Vista, CA (US); Josh Willis, Vista, CA (US)

(73) Assignee: Rayzist Photomask, Inc., Vista, CA (US)

(21) Appl. No.: 14/676,352

(22) Filed: Apr. 1, 2015

Related U.S. Application Data
(60) Provisional application No. 61/973,383, filed on Apr. 1, 2014.

(51) Int. Cl. E04H 13/00; A61G 99/00

(52) U.S. Cl. CPC E04H 13/008; E04H 13/001; E04H 13/003; E04H 13/006; A61G 99/00

(57) ABSTRACT

The present invention provides, in at least one embodiment, a columbarium niche configured to store one or more urns holding a deceased's cremated remains. The columbarium niche includes an improved niche cover having a stone inlay inserted into a cut out portion of the niche cover and personalized and design engravings on the stone inlay. The stone inlay is easier to read and find due to a contrast in color and/or stone and eliminates the need for a conventional plaque on the surface of the niche cover. The personalized and design engravings on the niche cover from sandblasting or laser engraving add value due to the uniqueness, improved quality, and modern look.

### CROSS REFERENCE TO RELATED APPLICATIONS

This application claims priority under 35 U.S.C. §119(e) to U.S. Provisional Application No. 61/973,383, filed Apr. 1, 2014, and entitled “New columbarium and niche covers,” the disclosure of which is hereby incorporated by reference in its entirety.

### BACKGROUND OF THE INVENTION

1. Field of Invention

The invention relates generally to the memorial industry such as cemeteries, columbarium niches, and cremation, and more particularly, to an improved columbarium and niche cover as part of a columbarium niche for holding a deceased's cremated remains.

2. Description of Related Art

A columbarium is a housing, or free standing unit indoors or outdoors, with vaults lined with openings for holding ashes of the dead. The term columbarium can refer broadly to the housing itself, or narrowly to a room within the housing or a structure within the room. The term columbaria is the plural of columbarium.

Columbaria are typically beautiful and respectful public displays and for the storage of cinerary urns. Columbaria allow the family of the deceased to visit this respectful location to conduct traditional memorials and ancestor rites. Over history, columbaria have been built both above and below ground. Columbaria are usually built in a cemetery, church, temple or another respected location. Typical locations include a memorial garden, a church courtyard, or part of a monument or mausoleum. One famous location is the Cathedral of Our Lady of the Angels, in Los Angeles, which houses a number of columbarium niches in the mausoleum built into the lower levels of the Cathedral. Another famous location is the columbarium at Arlington National Cemetery, in Virginia, where each niche is covered with a marble plaque.

A columbarium niche, also referred to simply as a niche or a unit, is for the burial of cremated remains. A niche is a recessed compartment for holding ashes of the dead in an urn. The niche can be referred to as opening itself or a unit that is installed into the opening. The niche is typically installed besides many other niches, in rows and columns, in a columbarium. A closely related term to a niche is a crypt. A crypt is a space in a mausoleum or other building to hold cremated or whole remains, whereas similarly, a niche is a space in a columbarium, mausoleum or niche wall to hold an urn.

A niche cover, also referred to as a niche front, is the outer portion of the niche that is seen without opening the niche. Niche covers are often beautiful and respectful, with the deceased's information written thereupon. The material of the niche cover is often a high quality granite stone or marble.

A problem with conventional niche covers is clearly conveying the deceased's information. Conventional niche covers use granite, while beautiful, this stone creates a background that makes the deceased's information difficult to read. Further, the writing makes the niche difficult to find as well. This is important for columbaria, because a particular niche is typically positioned along with hundreds of other niches, in rows and columns in a columbarium, and often sought out by elderly friends or family.

Another problem with conventional niche covers is that most niche covers contain a plaque attached to the surface to add the deceased's information and let visitors know who is inside. Sometimes the plaques contain an engraving thereon, but those tend to not have the cleanest, most flush, and high quality look. The plaques are typically granite, marble, or bronze. A problem with the plaques is that they can easily be stolen by vandals because they adhere to the surface of a niche cover and sometimes the plaques have a high value. Similarly, the plaques can also easily be damaged by vandals ripping them off because they are held on by screws or adhesion and protrude from the niche covers.

A further problem with conventional niche covers is that their plaques, or alternatively their pure granite structure, lack modernistic and unique desirable structure features.

U.S. Pat. No. 6,088,973 to Weiss discloses monuments, markers and columbaria with improved display indicia. In a second aspect of Weiss, a columbarium niche structure is shown having a movable element positioned behind an opening in a door. The movable element is preferably recessed so that no portion thereof extends beyond the front face of the door, but is constructed so as to be accessible for manual movement to change the information displayed. In a fourth aspect of Weiss, a flush mounted metallic grave marker displays summary information about a deceased individual and includes additional structure for displaying more detailed information which cannot be readily formed on the surface of the metallic marker. However, Weiss' moveable element, located through a window inside the niche, lacks the beauty of a flush stone. And Weiss' mounted grave marker also lacks the beauty of a flush stone because it is a plaque and is not flush as alleged. Weiss' mounted grave marker has a first plate mounted on the surface of the niche and a second plate mounted on the first plate.

### SUMMARY OF THE INVENTION

The present invention provides, in at least one embodiment, a columbarium niche configured to store one or more urns holding a deceased's cremated remains. The columbarium niche includes an improved niche cover having a stone inlay inserted into a cut out portion of the niche cover and personalized and design engravings on the stone inlay. The stone inlay is easier to read and find due to a contrast in color and/or stone and eliminates the need for a conventional plaque on the surface of the niche cover. The personalized and design engravings on the niche cover from sandblasting or laser engraving add value due to the uniqueness, improved quality, and modern look.

In one embodiment, an apparatus comprises: a columbarium niche configured to store one or more urns; a niche cover on the columbarium niche, wherein the niche cover comprises a cut out portion; and a stone inlay configured to embed flush with the cut out portion of the niche cover, wherein the stone inlay is configured to have a personalized engraving or a design engraving.

In another embodiment, a method comprises the steps of: providing a columbarium niche configured to store one or more urns; providing a niche cover on the columbarium niche, wherein the niche cover comprises a cut out portion; and providing a stone inlay configured to embed flush with the cut out portion of the niche cover, wherein the stone inlay is configured to have a personalized engraving or a design engraving.

An advantage of the present invention is the stone inlay, also referred to as an insert, is easier to read than a traditional granite niche cover. The stone inlay is easier to read due to a contrast in color and/or stone. Additionally, the stone inlay makes the deceased information and the niche itself easier to find, which is important when sought by elderly friends and family among hundreds of other niches.

Another advantage is that the stone inlay eliminates the need for a conventional granite or bronze plaque attached to the surface to personalize the niche. With the new inlayed stone, the niche cover creates a plaque like look without adhering to a surface which can be stolen or damaged by vandals. The stone inlay keeps the quality of the cover very high, with a flush finish, and can reduce maintenance such as replacement of loose or rusty screws, or the plaque itself.

A further advantage of the present invention is personalized and design engravings via sandblasting or laser engraving which add value due to the uniqueness, improved quality, and modern look. The personalized engraving highlights whatever important information or design the deceased or their family decided to put on their niche cover. The engravings maintain the old fashioned benefits of a clean pure stone and the usefulness of identifying deceased information that last for a long time. Further, the two tone look with the stone and the inlay allow for very nice contrast. The improved niche cover provides permanency of personalization, creating a contrasted design with intricate detail and the ability to personalize as much as customer wishes, which is much more than just a sandblasted or laser designed name and date on a plaque or on the stone of a niche cover itself. The personalized and design engravings give a cremation garden a distinct clean look never offered or seen before.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, and the advantages thereof, reference is now made to the ensuing descriptions taken in connection with the accompanying drawings briefly described as follows:

FIG. 1 illustrates a columbarium according to an embodiment of the invention;

FIG. 2 illustrates a new columbarium according to an embodiment of the invention;

FIG. 3 illustrates an up close view of an improved niche from the columbarium according to an embodiment of the invention;

FIGS. 4-6 illustrate a method of creating a cut out portion in a niche cover according to an embodiment of the invention;

FIGS. 7-8 illustrate an stone inlay to insert into the cut out portion according to an embodiment of the invention;

FIGS. 9-13 illustrate refilling the cut out portion with the stone inlay and finishing the niche cover according to an embodiment of the invention; and

FIG. 14 illustrates a niche cover creation process according to an embodiment of the invention.

### DETAILED DESCRIPTION OF EMBODIMENTS

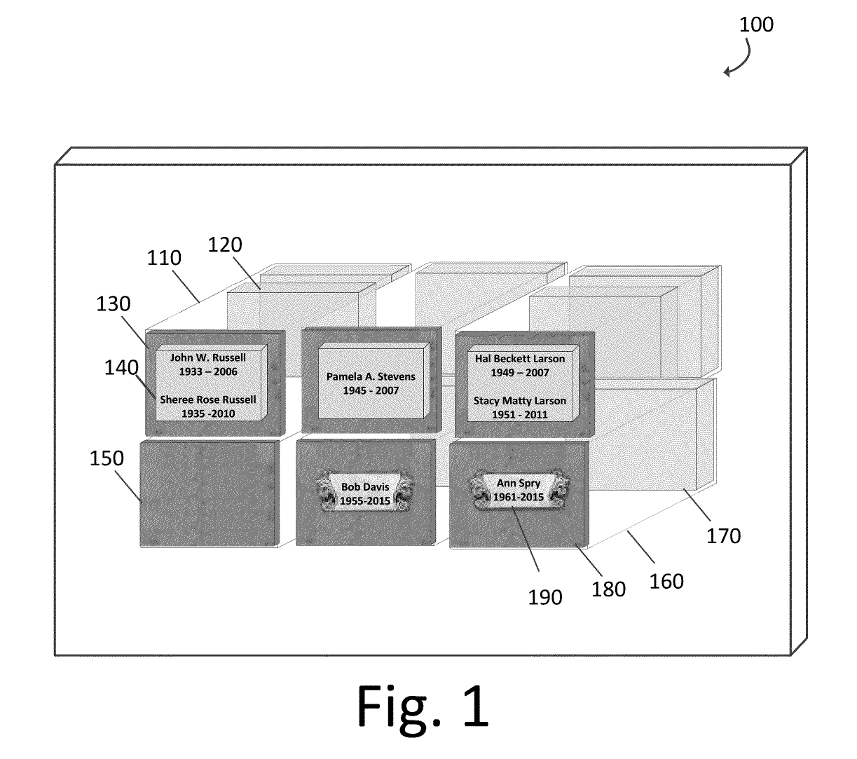

Further features and advantages of the invention, as well as the structure and operation of various embodiments of the invention, are described in detail below with reference to the accompanying FIGS. 1-14, wherein like reference numerals refer to like elements.

Although the columbarium is illustrated with a particular number of niches, one of ordinary skill in the art would realize that a columbarium could include many more niches, without departing from the spirit of the invention. Further, although a particular design was engraved into the stone inlays, many other designs could be used instead.

Embodiments of the present invention provide a new columbarium with new niche covers. The new niche covers are an improvement over conventional niche covers by providing a combination of a stone inlay coupled with a sandblasted design that has not been seen in this memorial field. Embodiments of the invention take a traditional granite cover and cut out a scroll, or any other design, out that can then be inlayed with another color or stone to create a contrast. In one embodiment, a granite or marble stone is cut out with a water jet machine using high pressure water and sand mixture. The water jet machine cuts a precision line allowing for the inlays to fit very close. This granite or other stone niche cover is then engraved to produce a niche cover not needing a plaque attached to surface, to personalize it. The engraving can use sandblasting or laser engraving to personalize the finished cover. The design can include the deceased's information and other ornaments. In one embodiment, the stone inlay is glued together with high strength epoxy resins. In another embodiment, grout is used with the stone inlay to insert the stone inlay flush with the niche cover.

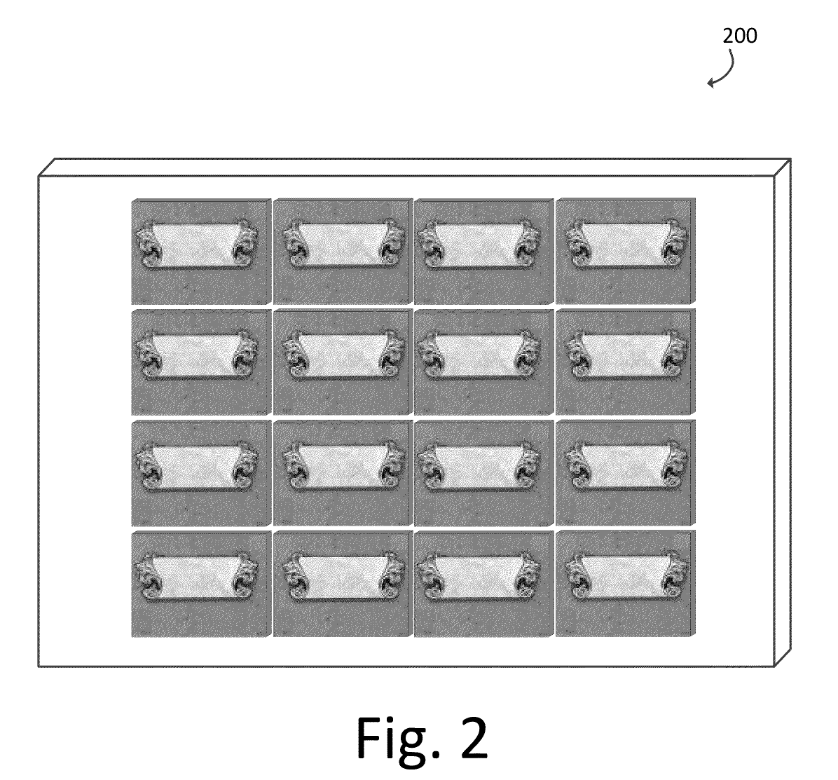

FIG. 1 illustrates a columbarium 100 according to an embodiment of the invention. The columbarium 100 includes a conventional columbarium niche 110 having one or more urns 120 and a conventional niche cover 130 having a plaque 140, an empty niche 150, an improved columbarium niche 160 having one or more urns 170 and an improved niche cover 180 including one or more stone inlays 190. The structure of the columbarium 100 provides a beautiful and respectful public location for the storage of cinerary urns. For comparison, the columbarium 100 includes a mixture of conventional niches 110 and the improved niches 160, whereas the columbarium in FIG. 2 illustrates only improved niches for a distinct clean look.

The conventional columbarium niche 110 is illustrated on the same row as two other conventional niches on the top row the columbarium 100. The niche 110 includes two urns 120 and a conventional niche cover 130. The two urns 120 hold the cremated remains of the two listed deceased on the niche cover 130. For comparison, conventional niche 110 is besides another conventional niche that contains a single urn for a single deceased. The conventional niche cover 130 is a pure granite stone with the deceased's information written thereupon, typically on the plaque 140. The plaque 140 is affixed to the niche cover 130 by an adhesive or screws.

The empty niche 150 represents a niche that has not been purchased or does not yet contain an urn. With columbaria often having hundreds of niches, it is common for many of the niches to have blank niche covers indicative that the niche is empty or available for purchase.

The improved columbarium niche 160, also referred to simply as niche 160, is illustrated with an urn 170, a niche cover 180 having a stone inlay 190. The urn 170 holds the cremated remains of the listed deceased on the niche cover 180.

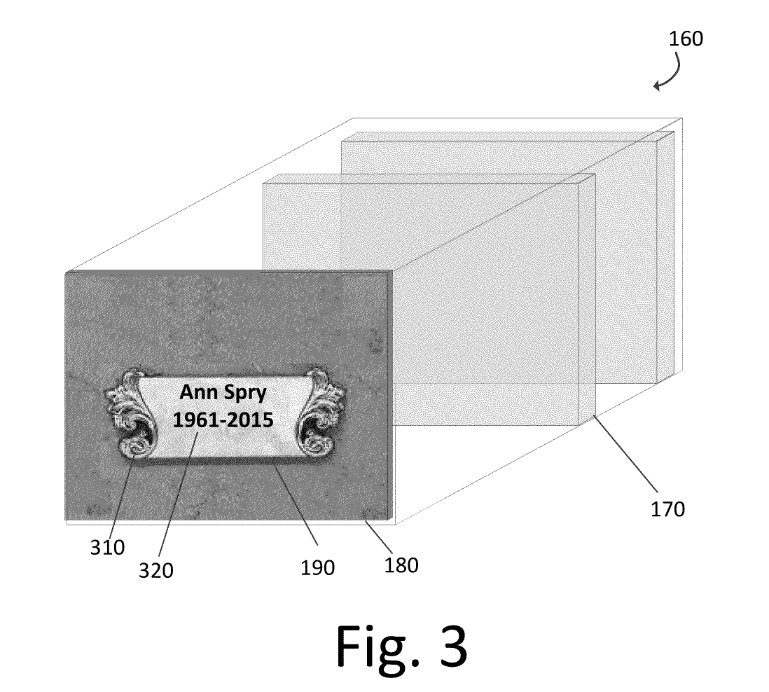

The niche cover 180, in embodiments, contains granite or marble stone, with a cut out portion filled with the stone inlay 190. The stone inlay 190 lists the deceased's information corresponding with the urn 170. The stone inlay 190 also contains personalized and design engravings illustrated and discussed in more detail in FIG. 3.

FIG. 2 illustrates a new columbarium 200 according to an embodiment of the invention. The columbarium 200 is a finished jobsite of niches that are awaiting to be sold and personalized, but already have an engraved design. Although a particular design is illustrated, many types of designs and stone inlays can be created using a variety of templates. For example, in another embodiment (not shown) a single design engraving spans across several niches in a row.

FIG. 3 illustrates an up close view of the niche 160 from the columbarium 100 according to an embodiment of the invention. The up close view illustrates a design engraving 310 and a personalized engraving 320. The design engraving 310 is a design that is sandblasted into a stone inlay. Although the niche 160 is described using a single stone inlay in the niche cover, one with ordinary skill in the art readily appreciates that the present invention can be implemented with more than one stone inlay, such as one per urn.

The personalized engraving 320 is personalized to the deceased's information or other information desired by the customer. The engraving 320 is sandblasted or laser engraved to personalize a finished niche cover. The combination of the stone inlay 190 coupled with a personalized engraving or a design engraving create a novel item that has not been seen in this field.

As a close up of FIG. 1, FIG. 3 illustrates that the urn 170 is often contained in a rectangular box like structure, as is known by those with skill in the art. The niche cover 180 contains a stone, such a granite or marble, bordering the stone inlay 190. The stone inlay 190 has a very high quality sandblasted or laser engraved design engraving 310 and personalized engraving 320. The design engraving 310 can be the design on the left and right of the deceased's information and the personalized engraving 320 can include the deceased's information or other information desired by the deceased or their family. The engravings 310, 320 are very beautiful and respectful, and with the sandblasting or laser engraving, very high quality.

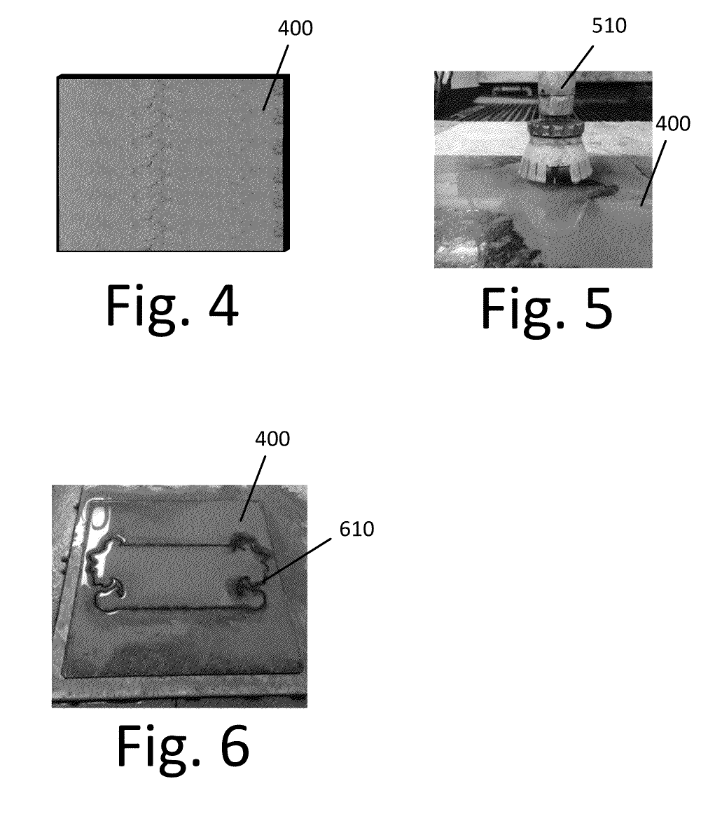

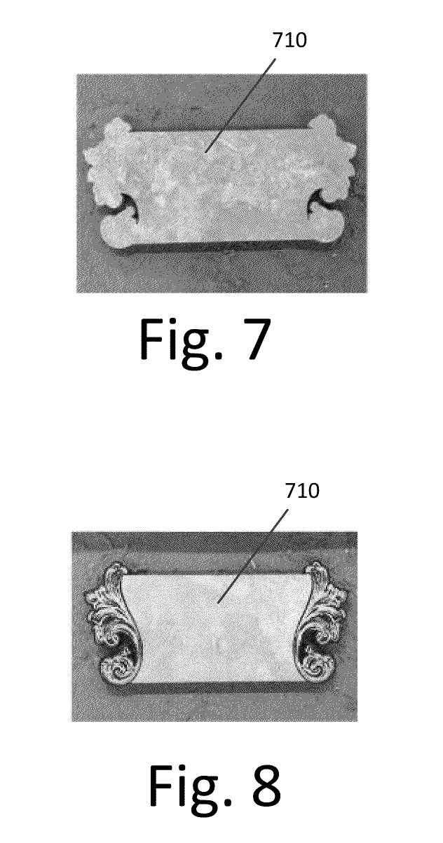

FIGS. 4-6 illustrate a method of creating a cut out portion in a niche cover according to an embodiment of the invention. FIG. 4 illustrates a stone 400, also referred to as a stone cut out or a niche cover. The stone can be granite or marble. FIG. 5 illustrates a water jet machine 510 cutting a precise incision into the stone 400. FIG. 6 illustrates that the water jet cuts a stone inlay (shown in FIG. 7, 710) out leaving a cut out portion 610, where the cut out portion 610 is the exact hole needed to reinsert the stone inlay into the stone 400 in some embodiments.

FIGS. 7-8 illustrate the stone inlay 710 from the stone 400 to refill the cut out portion 610 according to an embodiment of the invention. FIG. 7 illustrates the stone inlay 710 configured to be inserted into the stone 400 and having the exact size of the cut-out portion 610 of the stone 400. FIG. 8 illustrates the stone inlay 710 after a design is sandblasted into the stone inlay 710.

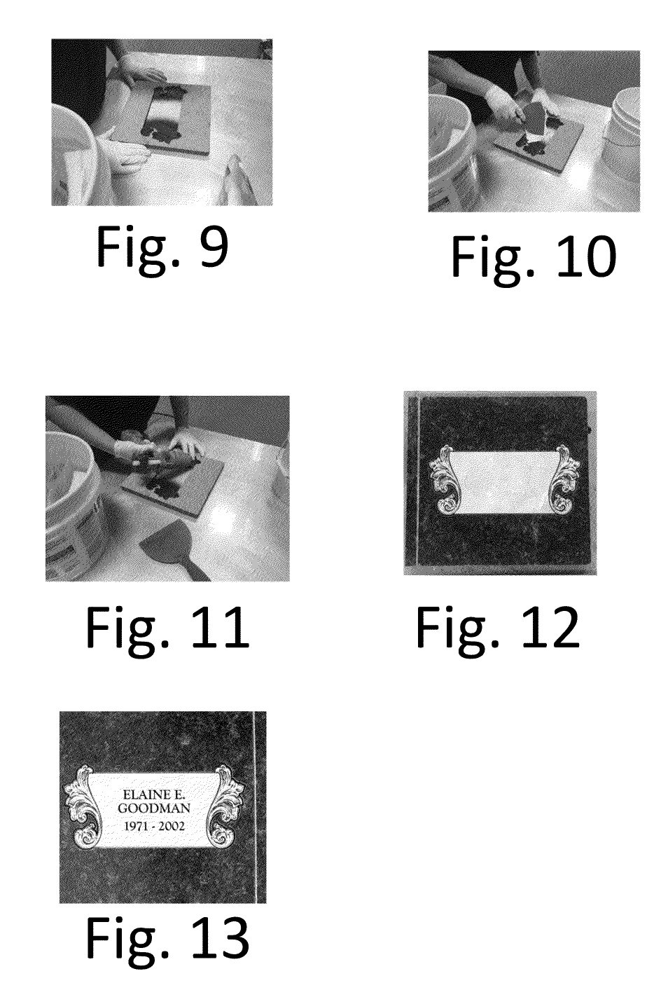

FIGS. 9-13 illustrate refilling the cut out portion with the stone inlay and finishing the niche cover according to an embodiment of the invention. FIG. 9 illustrates the backside of the stone inlay married together with the cut out portion of the stone such that the two are married or inlayed together. FIG. 10 illustrates a manufacturer applying a layer of quick set adhesive to the backside to hold the stone inlay and the stone in place. FIG. 11 illustrates epoxy being applied to the backside and filled completely to bond cut out of the stone and the stone inlay together. FIG. 12 illustrates the finished niche frontside that is ready to be personalized. FIG. 13 illustrates a personalized finished niche cover.

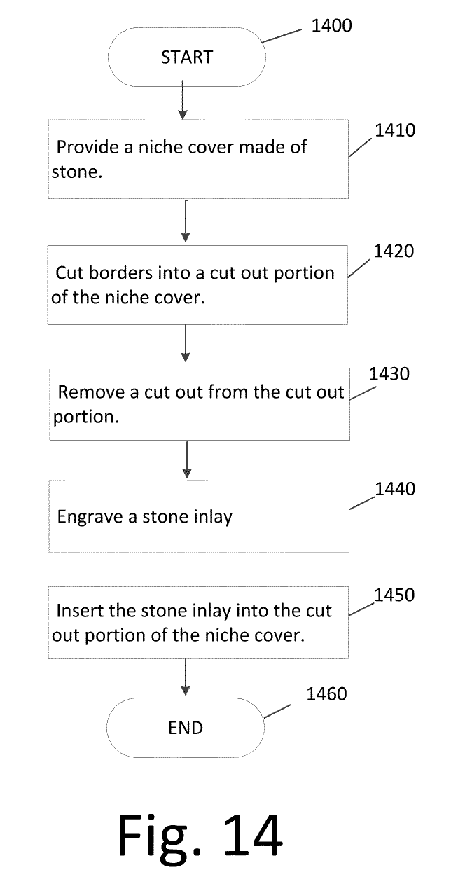

FIG. 14 illustrates a niche cover creation process according to an embodiment of the invention. The process starts at step 1400. At step 1410, a niche cover is provided. The niche cover is made of stone, such as granite or marble. At step 1420, a water jet machine cuts borders into a cut out portion of the niche cover. The cut out portion can be a scroll or any other design. At step 1430, a manufacturer removes a cut out from the cut out portion of the niche cover, where the cut out is the stone inlay in some embodiments.

Next, at step 1440, the manufacturer uses sandblasting or laser engraving to engrave a stone inlay. The engraving can include a design along with the information about the deceased, including a name, a date of birth, and a date of death. Then at step 1450, the manufacturer inserts the stone inlay flush into the cut out portion of the niche cover. The process ends at step 1460.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, for example, through multi-threaded processing, interrupt processing, or multiple processors, rather than sequentially.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

What is claimed is:

1. An apparatus comprising:
a columbarium niche configured to store one or more urns;
a niche cover on the columbarium niche, wherein the niche cover comprises a cut out portion; and
a stone inlay configured to embed flush with the cut out portion of the niche cover, wherein the stone inlay is configured to have a personalized engraving or a design engraving.

2. The apparatus of claim 1, wherein the stone inlay comprises a cut out from the niche cover to fill the cut out portion.

3. The apparatus of claim 1, wherein the stone inlay comprises a personalized engraving and a design engraving.

4. The apparatus of claim 1, wherein the stone inlay adds a color contrast to the niche cover.

5. The apparatus of claim 1, wherein the stone inlay adds another stone to the niche cover.

6. The apparatus of claim 1, wherein the niche cover is configured to provide deceased information without a plaque.

7. The apparatus of claim 1, wherein the cut out portion is cut using a water jet machine.

8. The apparatus of claim 1, wherein the design engraving is engraved by sandblasting.

9. The apparatus of claim 1, wherein the personalized engraving is engraved by laser engraving.

10. A method comprising:
providing a columbarium niche configured to store one or more urns;
providing a niche cover on the columbarium niche, wherein the niche cover comprises a cut out portion; and
providing a stone inlay configured to embed flush with the cut out portion of the niche cover, wherein the stone inlay is configured to have a personalized engraving or a design engraving.
